(19) United States
(12) Patent Application Publication
(10) Pub. No.: US 2018/0170546 A1
(43) Pub. Date: Jun. 21, 2018

(54) SIDE ROLLER ASSEMBLY FOR CARGO HANDLING SYSTEM

(71) Applicant: Goodrich Corporation, Charlotte, NC (US)

(72) Inventors: Vinodkumar Shivalinga, Bangalore (IN); Narain Jayaprakash, Bangalore (IN); Vikramkumar Bogar, Bangalore (IN); Wallace Harold Larson, Jamestown, ND (US); Mark L. Olson, Jamestown, ND (US)

(21) Appl. No.: 15/440,770

(22) Filed: Feb. 23, 2017

(30) Foreign Application Priority Data
Dec. 16, 2016 (IN) 201611043061

(51) Int. Cl. B64D 9/00; B65G 13/00

(52) U.S. Cl. CPC B64D 9/00; B64D 2009/006; B65G 13/00

(57) ABSTRACT

A cargo handling system for restraining a unit load device includes a structural channel having a hollow interior and at least one roller rotatably mounted within said hollow interior. At least one locking mechanism associated with said structural channel is movable to engage the unit load device. At least one side roller assembly is operably coupled to an exterior surface of said structural channel. The at least one side roller assembly includes a side roller positioned such that said an upper surface of said at least one roller and an upper surface of said side roller are disposed within a plane for supporting said unit load device.

### BACKGROUND

Embodiments of the present disclosure relate to mounting cargo in a cargo compartment of an aircraft, and more particularly, to a roller assembly for a cargo mounting system used in the cargo compartment.

Cargo handling systems are typically used in a variety of applications to move or situate cargo in a particular area of a vehicle, such as a ship, truck, or aircraft. An aircraft cargo handling system typically includes a roller conveyor system mounted to a cross beam of the aircraft which enables pallets or containers to be moved easily in and out of the aircraft cargo compartment. A unit load device (ULD) is a pallet or container used to load luggage, freight, and mail on a wide-body aircraft. The cargo handling system includes locking mechanisms capable of locking adjacent ULDs in place longitudinally along the roller conveyor.

While current aircraft cargo handling systems or methods have generally proven to be satisfactory for their applications, each is associated with its share of limitations. Inclusion of a roller near each locking mechanism is intended to support the ULD and prevent deflection of the cargo pallet. However, in systems having multiple locking mechanisms located near one another, it is difficult to position a roller within the roller tray there between. As a result, the ULD adjacent these locking mechanisms is more susceptible to deflection and may result in the unintentional release of the locking mechanism from the cargo.

### BRIEF DESCRIPTION

According to an embodiment, a cargo handling system for restraining a unit load device includes a structural channel having a hollow interior and at least one roller rotatably mounted within said hollow interior. At least one locking mechanism associated with said structural channel is movable to engage the unit load device. At least one side roller assembly is operably coupled to an exterior surface of said structural channel. The at least one side roller assembly includes a side roller positioned such that said an upper surface of said at least one roller and an upper surface of said side roller are disposed within a plane for supporting said unit load device.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a side view of an example of a cargo handling system;

FIG. 2 is a cross-sectional view of the example of a cargo handling system of FIG. 1;

FIG. 3 is a perspective view of a cargo handling system including a side roller assembly according to an embodiment;

FIG. 4 is a side view of a cargo handling system including a side roller assembly according to an embodiment;

FIG. 5 is an end view of a portion of a cargo handling system including a side roller assembly according to an embodiment; and

FIGS. 6A-6C are various view of a side roller assembly according to an embodiment; and

FIGS. 7A-7C are various view of a side roller assembly according to another embodiment.

### DETAILED DESCRIPTION

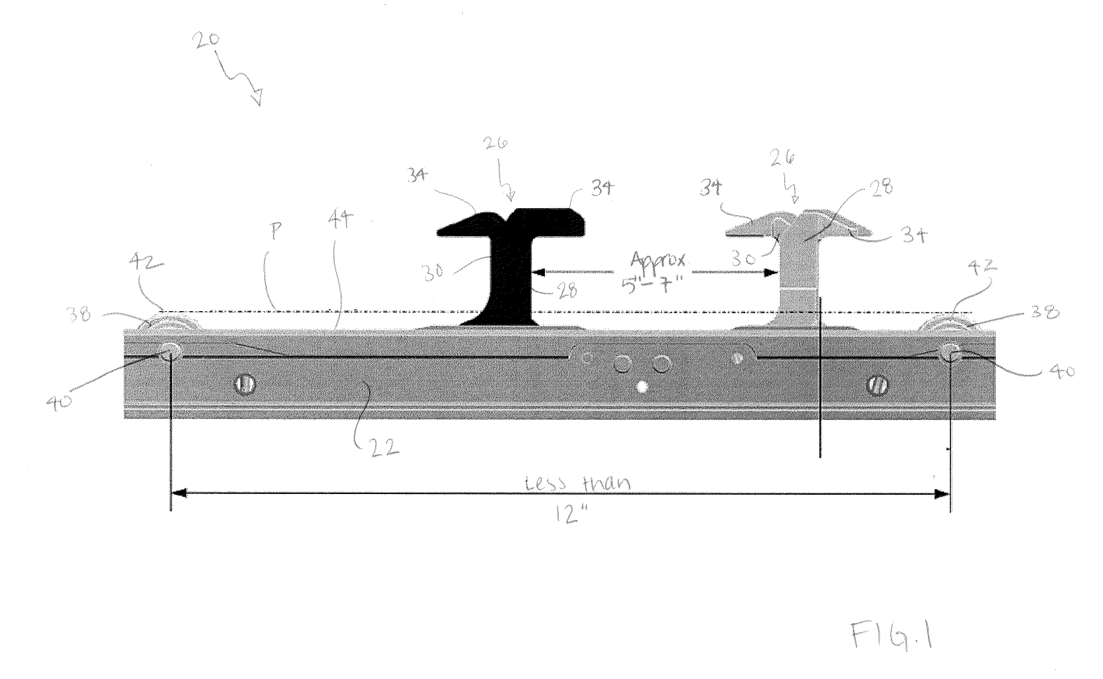

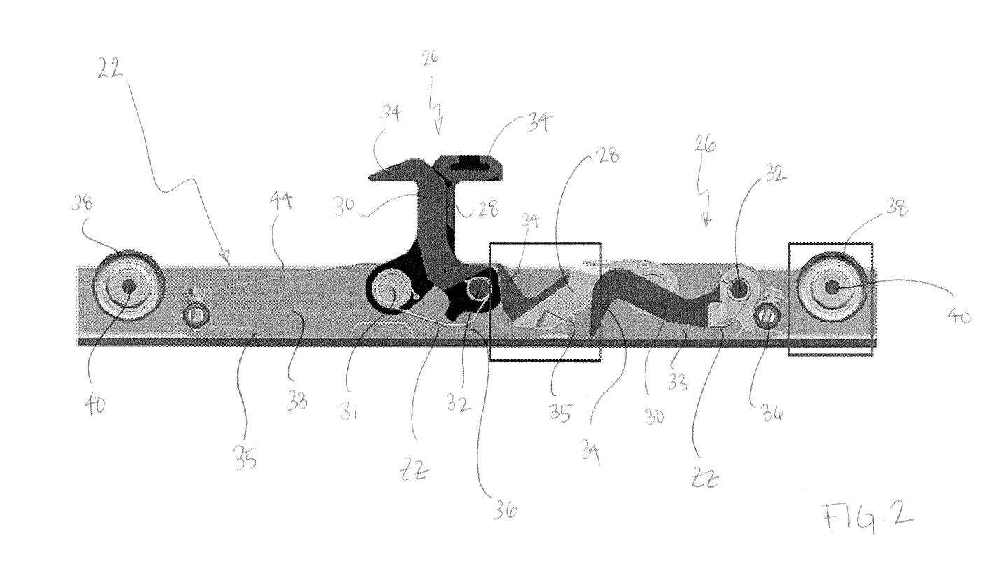

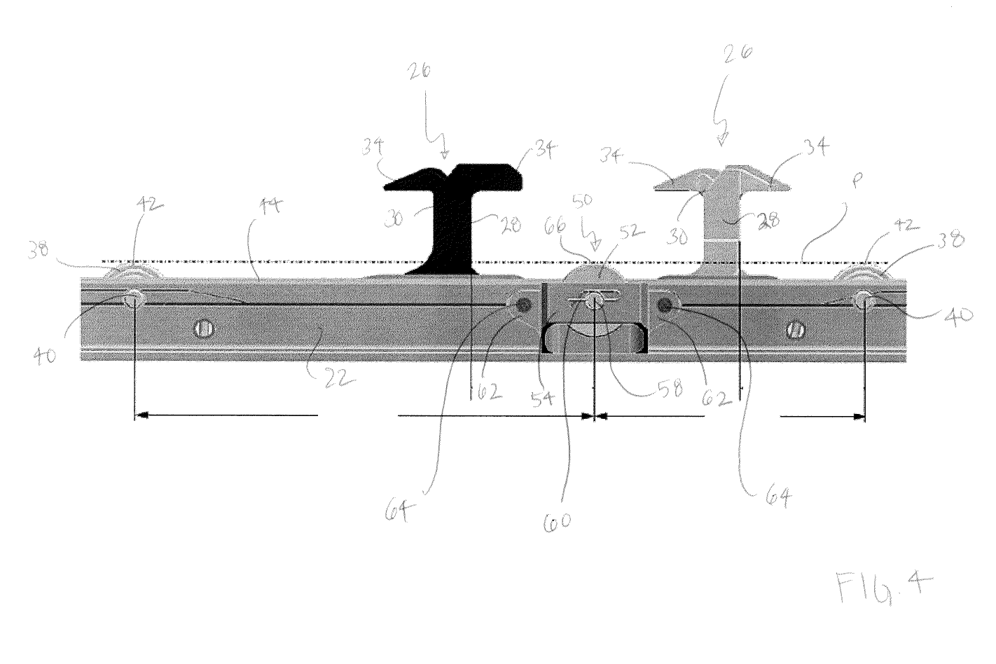

Referring now to FIGS. 1 and 2, an example of a cargo handling system 20 for use in an aircraft is illustrated. The cargo handling system 20 is intended to mount to the cross beam of an aircraft cargo compartment, which is typically supported by an aircraft substructure. The cargo handling system 20 includes a plurality of structural channels 22, also referred to as roller channels or trays, an example of which is illustrated in FIGS. 1 and 2. In the illustrated, non-limiting embodiment, the structural channel 22 is generally C-shaped (see FIG. 5) and is oriented such that the hollow interior 24 of the structural channel 22 faces vertically upward.

Each structural channel 22 includes one or more locking mechanisms 26 for locking one or more unit load devices (ULDs) in place relative to the system 20. As shown, one or more locking mechanisms 26 are generally positioned at a central portion of the structural channel 22; however, locking mechanisms 26 arranged at another location relative to the structural channel 22 are also contemplated herein. In the illustrated, non-limiting embodiment, a locking mechanism 26 includes both a first pawl 28 and a second pawl 30. The first pawl 28 is configured to rotate about a first pin 31 relative to the structural channel 22 between a first retracted position (FIG. 1) and a second engaged position (FIG. 2). Similarly, the second pawl 30 is configured to rotate about a second pin 32 relative to the structural channel 22 between a first retracted position and a second engaged position. In an embodiment, the first and the second pawl 28, 30 extend generally vertically in the retracted position and extend generally horizontally when in the engaged position. The first pin 31 and the second pin 32 are separated from one another by a horizontal distance such that the first pawl 28 and the second pawl 30 are independently rotatable. In an embodiment, however, the pawls 28, 30 are coupled by at least one spring ZZ to maintain contact between the pawls 28, 30 during rotation.

Each pawl 28, 30 may include a lip 34 configured to secure an adjacent cargo pallet (not shown) to the cargo handling system 20 when rotated to the engaged position. When the first and second pawl 28, 30 are both in the retracted position, the pawls 28, 30 are generally aligned with the lip 34 of the first pawl 28 extending in a first direction, and the lip 34 of the second pawl 30 extending in a second direction, such as opposite the first direction for example. In the engaged position, the pawls 28, 30 are configured to interlock with one another. For example, in an embodiment, a feature formed on the first pawl 28 engages a complementary feature on the second pawl 30 to limit unintended movement of the pawls 28, 30 beyond the engaged position. A stopper, such as a shaft or protrusion extending from a lock base plate 33 of the lock mechanism 26 may restrict rotation of the pawls 28 and 30 beyond the retracted position. As shown the first pawl 28 and the second pawl 30 are configured to contact stoppers 35 and 37, respectively, to prevent rotation beyond a desired position when rotated towards the retracted position. It should be understood that the locking mechanisms 26 illustrated and described herein are intended as an example only and that any suitable connector for securing cargo pallets to the structural channel is contemplated herein.

At least one roller 38 is mounted within the hollow interior 24 of the structural channel 22. As shown, each of a plurality of rollers 38 is mounted about a shaft or pin 40 extending horizontally between opposing sides of the channel 22. In an embodiment, the rotational axes of the plurality of rollers 38, defined by the supporting shafts 40, are generally parallel. Further the rotational axes of the rollers 38 may be parallel to a rotational axis of an adjacent locking mechanism 26. An upper surface 42 of the plurality of rollers 38 mounted to the structural channel 22 define a conveyor plane P (FIG. 1) along which one or more ULDs are moved. The rollers 38 are configured to support the ULDs as they move within the plane P. In an embodiment, the plane P is generally parallel to and vertically offset from an upper surface 44 of the structural channel 22. If the rollers 38 are substantially identical, the rollers 38 are generally mounted at a similar height relative to the structural channel 22. However, embodiments where one or more of the rollers 38 has a varied configuration, such as different diameter for example, are also contemplated herein, and the mounting position of the rollers 38 relative to structural channel 22 may vary accordingly.

Inclusion of a roller, such as roller 38 for example, near a locking mechanism 26 helps maintain the position of a ULD adjacent the locking mechanism 26, and reducing the risk of the locking mechanism 26 decoupling from the ULD. As a result, the horizontal distance between adjacent rollers 38 should be less than about 12 inches (about 30.48 cm). In embodiments where two locking mechanisms 26 are positioned relatively close to one another, such as less than 12 inches apart, and more specifically, between about 5 inches (about 12.7 cm) and about 7 inches (about 17.8 cm) apart for example, a roller 38 cannot be located within the hollow channel 24 between the locking mechanisms 26 due to the operational interference that would occur therewith.

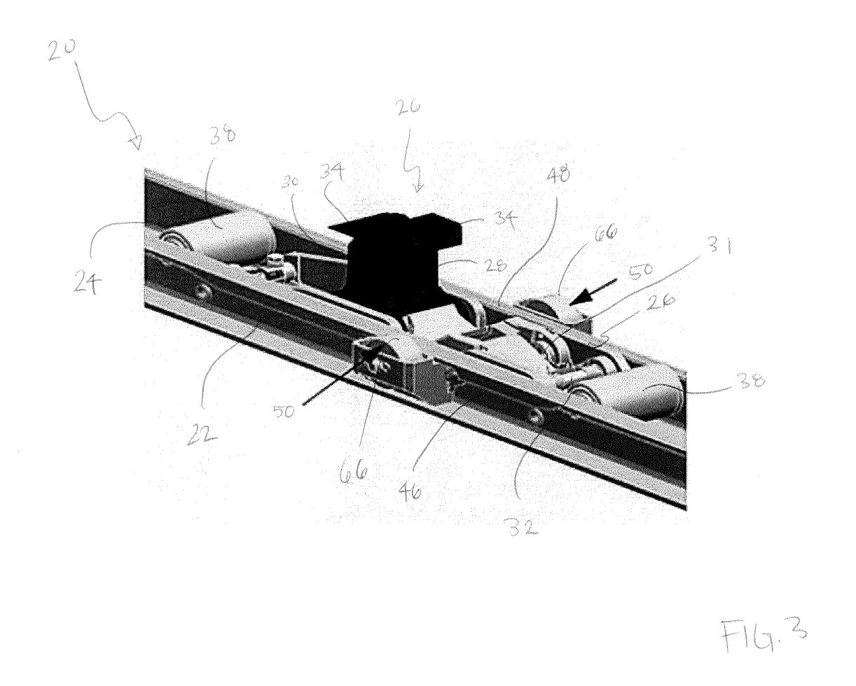

With reference now to FIGS. 3-5, one or more side roller assemblies 50 may be mounted to an exterior surface of the structural channel 22 at a horizontal position disposed between the first and second locking mechanisms 26. In the illustrated, non-limiting embodiment, a first side roller assembly 50 is mounted adjacent a first side 46 of the structural channel 22 and a second side roller assembly 50 is mounted adjacent a second, opposite side 48 of the structural channel 22. In embodiments including multiple side roller assemblies 50, the side roller assemblies may be substantially identical, or alternatively may be different.

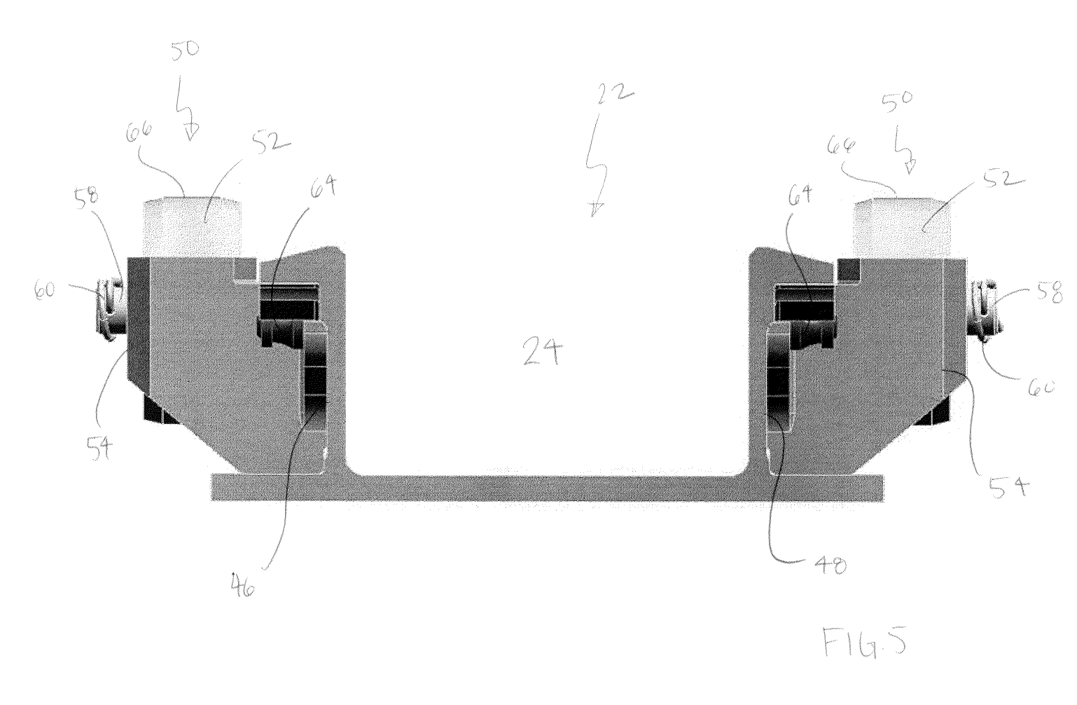

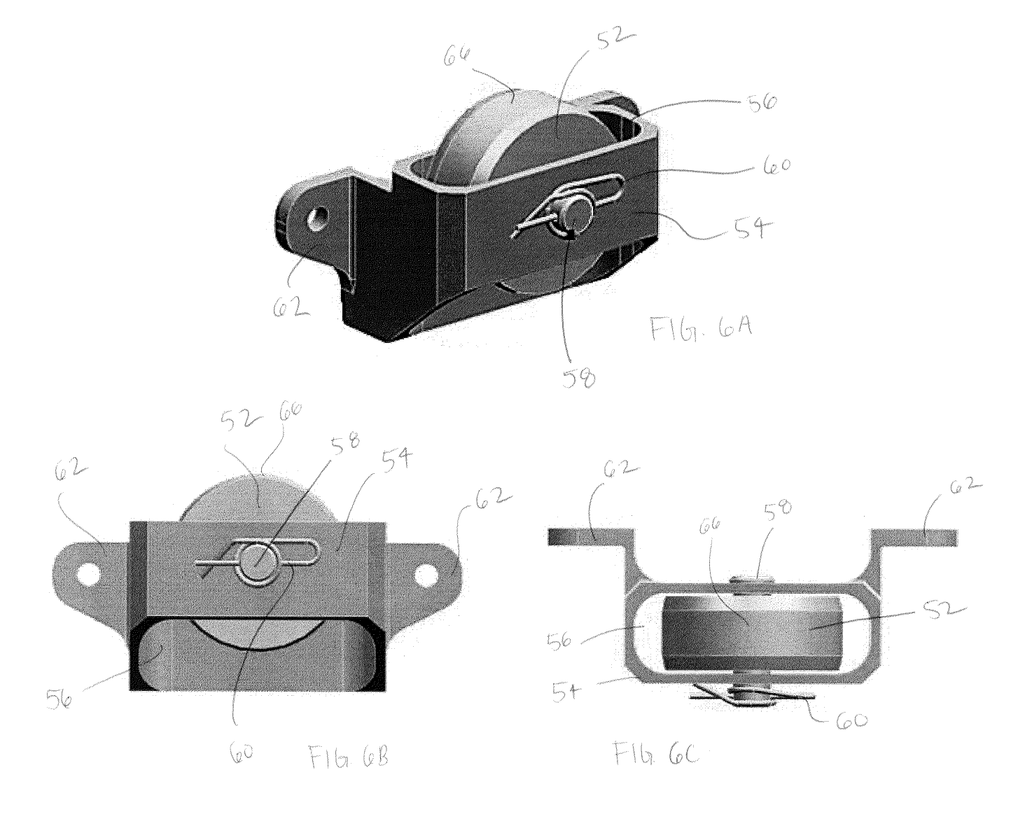

An example of a side roller assembly 50 is illustrated in more detail in FIGS. 6a-6c. The side roller assembly 50 includes a side roller 52 rotatably coupled to a housing or bracket 54. In an embodiment, the housing 54 defines a hollow interior 56 within which the side roller 52 is located. The side roller 52 may be supported by a shaft or pin 58 extending through one or more portions of the housing 54. For example, the pin 58 may extend through two portions of the housing 54 arranged on opposite sides of the hollow interior 56. A clip or other retention mechanism 60 may be coupled to an end of the pin 58, generally adjacent a surface of the housing 54 to restrict lateral movement of the pin 58 relative to the housing 54.

In the non-limiting embodiment of FIGS. 6A-6C, the housing 54 includes one or more flanges 62 for mounting to a surface of the structural channel 22, such as the first side 46 or second side 48 thereof for example. In an embodiment, the flanges 62 are generally offset from the portion of the housing 54 supporting the side roller 52. As a result, when the side roller assembly 50 is mounted to the structural channel 22, such as via a bolt or other fastener 64 extending through the flange 62, a clearance exists between the side of the structural channel 22 and the portion of the housing 54 supporting the side roller 52. The at least one flange 62 may include a generally planar surface having an orientation generally complementary to the structural channel 22. In an embodiment, the at least one flange 62 is configured such that when the side roller assembly 50 is mounted to the structural channel 22, the axis of rotation defined by the pin 58 is generally parallel to the axis of rotation of the rollers 38 mounted within the hollow interior 24 of the structural channel 22.

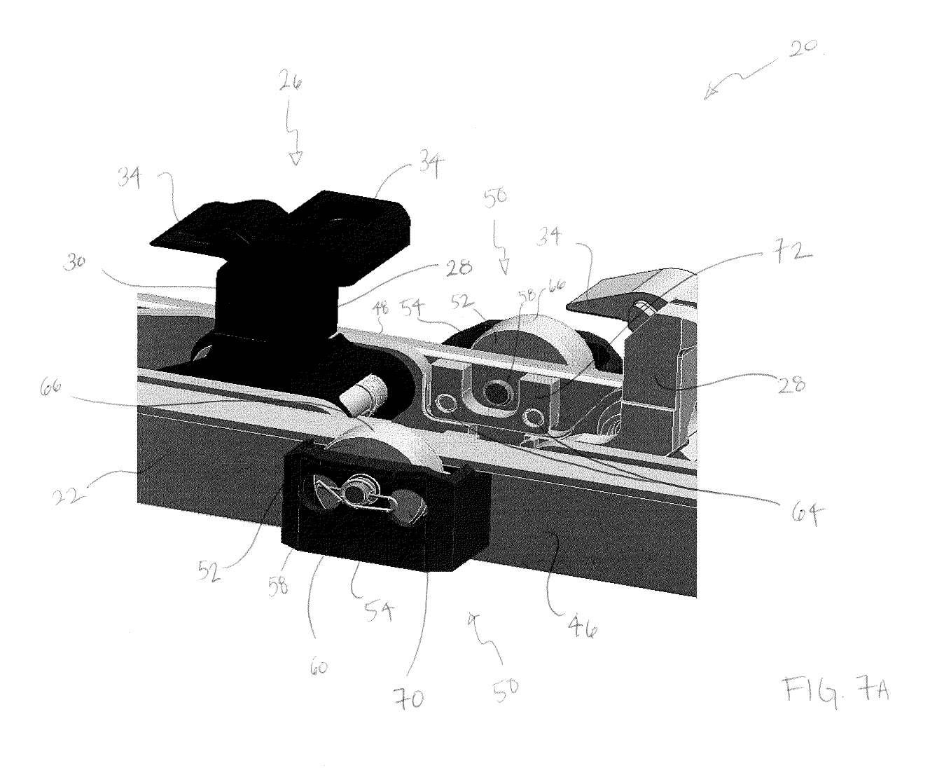

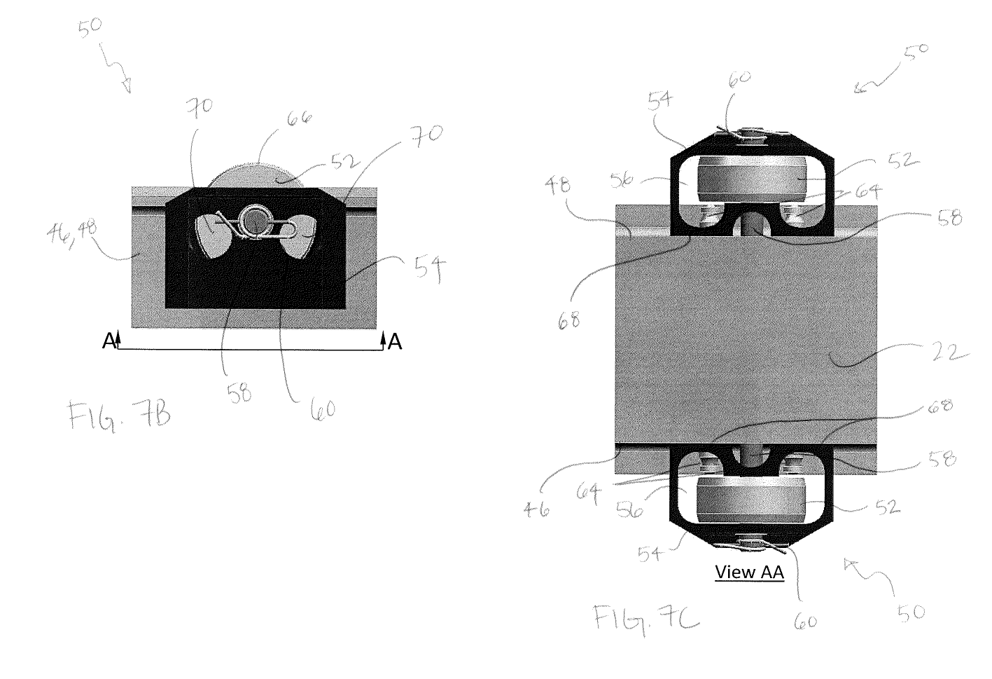

Another embodiment of the side roller assembly 50 is illustrated in FIGS. 7A-7C. As previously described, the side roller assembly 50 includes a side roller 52 rotatably coupled to a housing or bracket 54. The side roller 52 is supported within a hollow interior of the bracket 54 by a shaft or pin 58 extending there through, and a retention mechanism 60 may be coupled to the pin 58 to restrict lateral movement of the pin 58 relative to the housing 54. In an embodiment, the hollow interior 56 of the portion of the housing 54 that receives the pin 58 is narrower than other portions of the housing 54 to restrict lateral movement of the side roller 52 along the axis defined by the pin 58.

At least one surface 68 of the housing 54, arranged within a plane, is configured to contact a surface 46, 48 of the structural channel 22 when mounted thereto. In the configuration of the housing 54 of FIGS. 7A-7C, the one or more fasteners 64 are positioned within the hollow interior 56 and extend through the housing 54, including the at least one surface 68, and a portion of the structural channel 22 to mount the housing 54 to the structural channel 22. The housing 54 may include at least one hole 70 formed in a sidewall thereof to allow a tool to be inserted into the hollow interior 56 to access the one or more fasteners 64.

In an embodiment, a spacer 72 is positioned within the hollow interior 24 of the structural channel 22, adjacent the side roller assembly. The spacer 72 may be a separate component, or may be integrally formed with the structural channel 22. The spacer is sized and shaped such that the one or more fasteners 64 are received within the spacer 72.

Regardless of the configuration of the side roller assembly 50, in embodiments where side roller assemblies 50 are mounted on opposing sides of the structural channel 22, the side roller assemblies 50 may, but need not be, horizontally aligned. In general, the side roller assembly 50 should be positioned about the structural channel 22 such that a distance between an adjacent pawl 28, 30 in the retraced position and a rotational axis of the side roller 52 is less than or equal to about 2.5 inches. In addition, the housing 54 should be positioned relative to the structural channel 22 such that an upper surface 66 of the side roller 52 is aligned with the conveyor plane P defined by the other rollers 38.

Inclusion of at least one side roller assembly 50 at a position between adjacent locking mechanisms 26 provides added support for cargo located there between. As a result, the cargo is less likely to deflect below the conveyor plane P defined by the plurality of rollers and cause one of the locking mechanisms 26 to disengage from an adjacent ULD.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A cargo handling system for restraining a unit load device comprising:
a structural channel having a hollow interior;
at least one roller rotatably mounted within said hollow interior;
at least one locking mechanism associated with said structural channel, said at least one locking mechanism being movable to engage the unit load device; and
at least one side roller assembly operably coupled to an exterior surface of said structural channel, said at least one side roller assembly including a side roller, said side roller being positioned such that said an upper surface of said at least one roller and an upper surface of said side roller are disposed within a plane for supporting said unit load device.

2. The cargo handling system according to claim 1, wherein said plane defined by said at least one roller and said side roller is vertically offset from an upper surface of said structural channel.

3. The cargo handling system according to claim 1, wherein said plane defined by said at least one roller and said side roller is generally parallel to an upper surface of said structural channel.

4. The cargo handling system according to claim 1, wherein said at least one locking mechanism includes a first locking mechanism and a second locking mechanism, and said side roller assembly is mounted to said structural channel at a position between said first locking mechanism and said second locking mechanism.

5. The cargo handling system according to claim 4, wherein said at least one side roller assembly is separated from at least one of said first locking mechanism and said second locking mechanism by a distance less than or equal to about 2.5 inches.

6. The cargo handling system according to claim 1, wherein said at least one side roller assembly includes a first side roller assembly mounted to a first side of said structural channel and a second side roller assembly mounted to a second, opposite side of said structural channel.

7. The cargo handling system according to claim 6, wherein said first side roller assembly and said second side roller assembly are generally horizontally aligned.

8. The cargo handling system according to claim 1, wherein said at least one side roller assembly further comprises a housing associated with said side roller, said housing defines a hollow interior within which said side roller is located.

9. The cargo handling system according to claim 8, wherein a clearance exists between said external surface of said structural channel and said side roller.

10. The cargo handling system according to claim 8, wherein said side roller assembly further comprises:
a shaft for rotatably mounting said side roller to said housing; and
a retention mechanism mounted to said shaft adjacent said housing to restrict lateral movement of said shaft relative to said housing.

11. The cargo handling system according to claim 8, wherein said housing further comprises a flange for mounting said housing to said exterior surface of said structural channel.

12. The cargo handling system according to claim 9, wherein said flange is mounted to said structural channel with at least one fastener.

13. The cargo handling system according to claim 8, wherein at least one fastener positioned within said hollow interior mounts said housing to said structural channel.

14. The cargo handling system according to claim 13, wherein said housing includes at least one hole formed therein for accessing said at least one fastener with a tool.

15. The cargo handling system according to claim 13, wherein said structural channel further comprises a spacer arranged within an interior thereof, said spacer positioned to receive said at least one fastener.

16. The cargo handling system according to claim 15, wherein said spacer is integrally formed with said structural channel.
